(19) United States
(12) Patent Application Publication
(10) Pub. No.: US 2018/0019469 A1
(43) Pub. Date: Jan. 18, 2018

(54) ALLOY POWDER FOR ELECTRODES, NEGATIVE ELECTRODE FOR NICKEL-HYDROGEN STORAGE BATTERIES USING SAME AND NICKEL-HYDROGEN STORAGE BATTERY

(71) Applicant: Panasonic Intellectual Property Management Co. Ltd., Osaka (JP)

(72) Inventors: HIDEAKI OHYAMA, Osaka (JP); FUMIO KATO, Osaka (JP); HAI-WEN LI, Fukuoka (JP); ETSUO AKIBA, Fukuoka (JP); GUOLIANG WANG, Hangzhou (CN)

(21) Appl. No.: 15/549,679

(22) PCT Filed: Jan. 25, 2016
(86) PCT No.: PCT/JP2016/000335

§ 371 Date: Aug. 9, 2017

(30) Foreign Application Priority Data
Mar. 31, 2015 (JP) 2015-070567

(51) Int. Cl. H01M 4/38; C22C 19/03; H01M 10/26; B22F 1/00; C22C 19/07; H01M 4/24; H01M 10/30; B22F 9/04

(52) U.S. Cl. CPC H01M 4/383; H01M 4/24; C22C 19/03; H01M 10/30; H01M 10/26; B22F 1/0003; C22C 19/07; B22F 2009/041; H01M 2300/0014

(57) ABSTRACT

Alloy powder for electrodes that includes particles of a hydrogen-absorbing alloy having an AB₂ type crystal structure. The hydrogen-absorbing alloy includes first elements that are located in an A site in the crystal structure and include Zr, and second elements that are located in a B site and include Ni and. Mn. The hydrogen-absorbing alloy includes a plurality of alloy phases having different Zr concentrations. In each of the alloy phases, the percentage of Zr in the first elements exceeds 70 atom %.

### PRIORITY

This is a National Stage Application under 35 U.S.C. §371 of International application Ser. No. PCT/JP2016/000335, with an international filing date of Jan. 25, 2016, which claims priority to Japanese Patent Application No. 2015-070567 filed on Mar. 31, 2015. The entire disclosures of International application Ser. No. PCT/JP2016/000335 and Japanese Patent Application No. 2015-070567 are hereby incorporated herein by reference.

### TECHNICAL FIELD

The present invention relates to alloy powder for electrodes containing a hydrogen-absorbing alloy having an AB₂ type crystal structure, a negative electrode for nickel-hydrogen storage batteries using the alloy powder, and a nickel-hydrogen storage battery.

### BACKGROUND ART

A nickel-hydrogen storage battery including a negative electrode that includes a hydrogen-absorbing alloy as a negative electrode active material has a high output characteristic and a high durability (for example, life characteristic and/or conservation characteristic). Therefore, such an alkaline storage battery receives attention as an alternative of a dry battery or as a power source of an electric automobile, for example. While, recently, a lithium-ion secondary battery is also used for such an application. Therefore, from the viewpoint of emphasizing the advantage of the alkaline storage battery, it is desired to further improve battery characteristics such as capacity, output characteristic, and/or life characteristic.

A hydrogen-absorbing alloy generally includes elements of a high hydrogen affinity and elements of a low hydrogen affinity. Examples of the hydrogen-absorbing alloy include crystal structures of AB₅ type (for example, CaCu₅ type), of AB₃ type (for example, CeNi₃ type), and of AB₂ type (for example, MgCu₂ type). The hydrogen-absorbing alloy having the AB₂ type crystal structure receives attention because a high capacity is easily obtained. In this crystal structure, the elements of a high hydrogen affinity are apt to be located in an A site, and the elements of a low hydrogen affinity are apt to be located in a B site.

In order to improve the battery characteristics of a nickel-hydrogen storage battery, an attempt to optimize the performance of the hydrogen-absorbing alloy powder having an AB₂ type crystal structure is made.

For example, from the viewpoint of improving the initial activity and cycle life, Patent Literature 1 proposes that a product formed by bonding, together, particles A and particles B of hydrogen-absorbing alloys that have a Zr—Ni type Laves phase structure and have different compositions is used for an electrode. This bonding is performed in a sintering method or a mechanochemical method.

From the viewpoint of improving the rate characteristic, Patent Literature 2 proposes that a hydrogen-absorbing alloy in which two or more alloy phases are included and the amount of Zr in at least one phase is 70 atom % or less is used for a negative electrode of a secondary battery.

From the viewpoint of suppressing the cycle deterioration, Patent Literature 3 proposes an electrode including an AB₂ type hydrogen-absorbing alloy that has a composite phase structure formed of a main phase—namely, a Ti—Mo—Ni crystal phase and an auxiliary phase. The surface area percentage of the auxiliary phase in the cross section is 5 to 20%.

### CITATION LIST

### Patent Literature

PTL 1: Unexamined Japanese Patent Publication No. H09-161790

PTL 2: Unexamined Japanese Patent Publication No. H07-114921

PTL 3: Unexamined Japanese Patent Publication No. H06-310139

### SUMMARY OF THE INVENTION

The hydrogen-absorbing alloy having an AB₂ type crystal structure has a somewhat high capacity, for example about 1.3 times that of the hydrogen-absorbing alloy having an AB₅ type crystal structure, but disadvantageously has a high hydrogen equilibrium pressure and a short cycle life. In Patent Literatures 1 to 3, it is difficult to sufficiently reduce the hydrogen equilibrium pressure.

The objective of the present invention is to provide alloy powder for electrodes that has a high capacity and a low equilibrium pressure, a negative electrode for nickel-hydrogen storage batteries using the alloy powder, and a nickel-hydrogen storage battery.

One aspect of the present invention relates to alloy powder for electrodes that includes particles of a hydrogen-absorbing alloy having an AB₂ type crystal structure. The hydrogen-absorbing alloy includes first elements that are located in an A site in the crystal structure and include Zr, and second elements that are located in a B site in the crystal structure and include Ni and Mn. The hydrogen-absorbing alloy includes a plurality of alloy phases having different Zr concentrations. In each of the alloy phases, the percentage of Zr in the first elements exceeds 70 atom %.

Another aspect of the present invention relates to a negative electrode for nickel-hydrogen storage batteries that includes the alloy powder for electrodes as a negative electrode active material.

Yet another aspect of the present invention relates to a nickel-hydrogen storage battery that includes a positive electrode, the negative electrode, a separator interposed between the positive electrode and negative electrode, and an alkaline electrolytic solution.

The present invention can provide alloy powder for electrodes that has a high capacity and a low hydrogen equilibrium pressure. The alloy powder for electrodes is appropriate for use in a negative electrode for nickel-hydrogen storage batteries.

### BRIEF DESCRIPTION OF DRAWINGS

FIG. 1 is a vertical sectional view schematically showing the structure of a nickel-hydrogen storage battery in accordance with an exemplary embodiment of the present invention.

FIG. 2 is a diagram showing an image observed by taking, with a scanning electron microscope (SEM), the cross section of a hydrogen-absorbing alloy obtained in example 2.

### DESCRIPTION OF EMBODIMENT(S)

### Alloy Powder for Electrodes

The alloy powder for electrodes of an exemplary embodiment of the present invention includes particles of a hydrogen-absorbing alloy having an AB₂ type crystal structure. The hydrogen-absorbing alloy includes first elements (referred to also as “A-site elements”) that are located in an A site in the AB₂ type crystal structure and include Zr, and second elements (referred to also as “B-site elements”) that are located in a B site and include Ni and Mn. The hydrogen-absorbing alloy includes a plurality of alloy phases having different Zr concentrations. In each of the alloy phases, the percentage of Zr in the first elements exceeds 70 atom %.

A hydrogen-absorbing alloy (hereinafter, simply referred to also as “AB₂-type hydrogen-absorbing alloy”) having an AB₂ type crystal structure generally has a low reaction activity. In the present exemplary embodiment, the B-site elements in the hydrogen-absorbing alloy include Ni, so that a high reaction activity can be secured. When the hydrogen-absorbing alloy contains Ni, however, the amount of hydrogen absorbed is apt to decrease and the hydrogen equilibrium pressure is apt to increase. In the present exemplary embodiment, the hydrogen-absorbing alloy includes a plurality of alloy phases having different Zr percentages. Therefore, a Zr concentration gradient occurs between the alloy phases, and thus, a path through which hydrogen passes is formed in the hydrogen-absorbing alloy. Furthermore, the Zr percentage in each alloy phase is high, and the B-site elements include Mn. Therefore, the lattice constant of the crystal structure increases and hydrogen is apt to be absorbed. From these viewpoints, the hydrogen equilibrium pressure can be reduced. The decrease in hydrogen equilibrium pressure can improve the rate characteristic and low-temperature discharge characteristic. Furthermore, since the Zr percentage in each alloy phase is high, the hydrogen absorbing performance increases and hence a high capacity can be secured.

The A-site elements are required to include at least Zr in the whole hydrogen-absorbing alloy, and may include Zr and another element L. Preferably, the A-site elements in each alloy phase include Zr, or Zr and element L. Preferably, examples of element L include the elements (Ti and/or Hf) in group 4 on the periodic table other than Zr. The A-site elements may include only Zr. However, it is preferable that the A-site elements may include Zr and Ti, because the homogeneity of the hydrogen-absorbing alloy increases.

The percentage of Zr in the A-site elements in each of a plurality of alloy phases is required to exceed 70 atom %, preferably the percentage is 80 atom % or more. The percentage may be 90 atom % or more. Preferably, the percentage of Zr in the A-site elements is in such a range also in the whole hydrogen-absorbing alloy. When the percentage of Zr is in the range, a high hydrogen absorbing performance is easily secured.

When the A-site elements include Ti, it is preferable that molar ratio α¹ of Ti to the A-site elements satisfies 0.05≦α¹. The molar ratio may satisfy 0.05≦α¹≦0.30 or 0.05≦α¹0.20, or may satisfy 0.05≦α¹0.15.

The B-site elements are required to include at least Ni and Mn in the whole hydrogen-absorbing alloy, and may include element E in addition to Ni and Mn. Preferably, the B-site elements in each alloy phase include Ni and Mn, or Ni, Mn, and element E.

Molar ratio x of Ni to the A-site elements satisfies 0.80≦x≦1.50 in each alloy phase for example, preferably satisfies 0.90≦x≦1.50. It is preferable that molar ratio x to the whole hydrogen-absorbing alloy is also in such a range. When molar ratio x is also in such a range, a high reaction activity can be secured and a high capacity is easily secured.

Molar ratio y of Mn to the A-site elements in the whole hydrogen-absorbing alloy satisfies 0.05≦y≦1.50 for example, and may satisfy 0.10≦y≦1.30. When molar ratio y is also in such a range, the hydrogen equilibrium pressure is easily and further reduced, and the decrease in the cycle life and conservation characteristic is easily suppressed.

Examples of element E include at least one element selected from a set consisting of: the transition metal elements (except Ni and Mn) in groups 5 to 11 on the periodic table; the elements in group 12; the elements in group 13 periods 2 to 5; the elements in group 14 periods 3 to 5; and P. Examples of the transition metal elements include V, Nb, Ta, Cr, Mo, W, Fe, Co, Pd, Cu, and Ag. Examples of the elements in group 12 include Zn or the like. Examples of the elements in group 13 include B, Al, Ga, and In. Examples of the elements in group 14 include Si, Ge, and Sn. Preferably, element E is at least one element selected from a set consisting of V, Nb, Ta, Cr, Mo, W, Fe, Co, Cu, Ag, Zn, Al, Ga, In, Si, Ge, and Sn.

Preferably, the B-site elements include Al.

When the B-site elements include Al, it is preferable that molar ratio z¹ of Al to the A-site elements satisfies 0.05≦z¹≦0.45 in each alloy phase for example, preferably satisfies 0.15≦z¹≦0.45, and may satisfy 0.20≦z¹≦0.45. Molar ratio z¹ of Al to the whole hydrogen-absorbing alloy may be also in such a range. When the molar ratio z¹ is also in this range, the capacity is easily increased and self-discharge is easily suppressed.

The B-site elements may include Al, and an element (element El¹), of elements E, other than Al. Examples of element E¹ include, preferably, at least one element selected from a set consisting of Co, Cr, Si, and V, or may include Co and/or Cr. It is preferable to employ Co from the viewpoint of improving the reaction activity, or to employ Cr from the viewpoint of improving the corrosion resistance. From the viewpoint of further reducing the hydrogen equilibrium pressure, it is also preferable to employ V. When the B-site elements include element E¹, molar ratio z² of element E¹ to the A-site elements satisfies 0.01≦z²≦0.40 in each alloy phase for example, or may satisfy 0.05≦z²≦0.40 or 0.05≦z²≦0.25.

The molar ratio (namely, B/A ratio) of the B-site elements to the A-site elements is 1.50 to 2.50 in the whole hydrogen-absorbing alloy for example, preferably 1.70 to 2.40, more preferably 1.80 to 2.30. When the B/A ratio is in such a range, a high capacity is easily secured.

The plurality of alloy phases mean two or more alloy phases having different compositions. When the constituent elements of the plurality of alloy phases are different from each other, the plurality of alloy phases are classified as alloy phases having different compositions. When the constituent elements of the plurality of alloy phases are the same but the composition difference of at least one element between the alloy phases is 15 atom % or more for example, the alloy phases are classified as alloy phases having different compositions.

The plurality of alloy phases may be included in the hydrogen-absorbing alloy at the same degree of percentage, but may include a main phase and an auxiliary phase formed in the main phase. The auxiliary phase may be dispersed in the main phase.

The main phase means an alloy phase whose volume percentage in the hydrogen-absorbing alloy is 50% or more, and the auxiliary phase means an alloy phase whose volume percentage in the hydrogen-absorbing alloy is less than 50%. When the main phase is distinguished from the auxiliary phase on the basis of the electron micrograph or the like of the cross section of the hydrogen-absorbing alloy, the surface area percentage in the cross section may be used as the reference. For example, the alloy phase in which the surface area percentage in the cross section is 50% or more may be used as a main phase, and the alloy phase in which the surface area percentage is less than 50% may be used as an auxiliary phase. The surface area percentage (or volume percentage) of the auxiliary phase in the cross section of the hydrogen-absorbing alloy is preferably 0.1 to 20%, more preferably 0.1 to 10% or 0.1 to 5%.

The auxiliary phase may be formed of a plurality of auxiliary phases having different compositions. For example, the hydrogen-absorbing alloy may include a main phase, a first auxiliary phase formed in the main phase, and a second auxiliary phase that is formed in the main phase and has a composition different from that of the first auxiliary phase. When the hydrogen-absorbing alloy includes a plurality of auxiliary phases, it is preferable that the sum total of the surface area percentages (or volume percentages) of these auxiliary phases satisfy the above-mentioned range.

Each alloy phase can include a plurality of crystal particles. For example, the main phase may be formed of a plurality of crystal particles. The auxiliary phase may be an interface layer that is formed in a layer shape on the interface between adjacent crystal particles in the main phase. By forming the interface layer, a path of hydrogen is formed, and the effect of reducing the hydrogen equilibrium pressure is further enhanced.

The B/A ratio in the main phase is 1.50 to 2.50 for example, preferably 1.90 to 2.40, more preferably 1.90 to 2.30 or 1.90 to 2.20. When the B/A ratio in the main phase is in such a range, a high hydrogen absorbing performance can be secured by the main phase.

The B/A ratio in the interface phase is preferably less than 2.00, for example. The B/A ratio may be 1.90 or less or 1.80 or less. It is also preferable that the B/A ratio in the interface phase is lower than the B/A ratio in the main phase. In this case, the hydrogen absorbing performance of the interface phase is low, and the electronic conductivity and hydrogen diffusivity is increased by the interface phase. Therefore, hydrogen is easily and efficiently diffused in the main phase for absorbing hydrogen.

The interface phase is formed when a hydrogen-absorbing alloy is manufactured by a rapid solidification method (melt-spun method), and is not recognized when a casting method as a typical manufacturing method of a hydrogen-absorbing alloy is employed. When the hydrogen-absorbing alloy is manufactured, the interface phase can be formed as a thermodynamic energy-minimum-phase dependently on the direction of crystal growth.

In the main phase, percentage R_{zp} of Zr in the A-site elements is preferably 85 atom % or more, more preferably 90 atom % or more or 92 atom % or more. The upper limit of R_{zp} is 100 atom %. When R_{zp} is in such a range, the hydrogen absorbing performance of the hydrogen-absorbing alloy of the main phase can be easily and further improved.

In the auxiliary phase, percentage R_{zs} of Zr in the A-site elements may be 70 to 90 atom %, or may be 80 to 90 atom % or 80 to 88 atom %, for example. When R_{zs} is in such a range, a hydrogen path is apt to be formed, and the hydrogen diffusivity in the hydrogen-absorbing alloy can be further increased. When the hydrogen-absorbing alloy includes a plurality of auxiliary phases, it is preferable that the percentage of Zr in each auxiliary phase is in such a range.

Preferably, percentage R_{zp} is higher than percentage R_{zs}. Percentage R_{zp} and percentage R_{zs} preferably satisfy 1.00<R_{zp}/R_{zs}≦1.50, more preferably satisfy 1.05≦R_{zp}/R_{zs}≦1.30 or 1.05≦R_{zp}/R_{zs}≦1.20. When ratio R_{zp}/R_{zs} is in such a range, a hydrogen path is apt to be formed in the auxiliary phase, the hydrogen diffusivity can be increased, and a high hydrogen absorbing performance can be easily secured by the main phase. The difference in volume expansion during charge or discharge between the main phase and the auxiliary phase can be reduced, and hence the cycle life can be improved.

Percentage r_{zp} of Zr in the main phase (specifically, the sum total of the A-site elements and B-site elements) is preferably 15 to 30 atom %, more preferably 20 to 30 atom %.

Percentage r_{zs} of Zr in the auxiliary phase (specifically, the sum total of the A-site elements and B-site elements) is preferably higher than percentage r_{zp}. Percentage r_{zs} is more than 30 atom % and 45 atom % or less, for example, and is preferably 32 to 40 atom %. When the hydrogen-absorbing alloy includes a plurality of auxiliary phases, it is preferable that the sum total of the percentages of Zr in the auxiliary phases is in such a range.

When percentages r_{zp} and r_{zs} are in such ranges, the effect of securing a high hydrogen absorbing performance is further enhanced, and the hydrogen diffusivity increases. Therefore, the effect of reducing the hydrogen equilibrium pressure can be further enhanced.

Molar ratio y of Mn to the main phase preferably satisfies 0.40≦y≦1.10, more preferably satisfies 0.5≦y≦1.10 or 0.80≦y≦1.10. It is preferable that molar ratio y of Mn to the auxiliary phase (interface layer or the like) is lower than that to the main phase. That is because, in this case, a hydrogen path is apt to be formed by the auxiliary phase, and the hydrogen diffusivity is apt to be increased. When molar ratio y of Mn to the auxiliary phase (interface layer or the like) is lower than that to the main phase, a hydrogen path is apt to be formed by the auxiliary phase, and the hydrogen diffusivity is apt to be increased. The ratio of the molar ratio of Mn to the auxiliary phase to the molar ratio of Mn to the main phase is preferably more than 1.00 and 1.50 or less, more preferably 1.05 to 1.20, for example.

The alloy powder for electrodes may be produced by activation by alkali treatment. By the alkali treatment, the film of a Zr oxide formed on the particle surface of the hydrogen-absorbing alloy is removed or reduced. Thus, the hydrogen-absorbing alloy is activated. The amount of the Zr oxide inactive to a battery reaction is decreased, so that the rate characteristic and low-temperature discharge characteristic can be further improved.

From the viewpoint of the cycle life and high capacity, the average particle diameter of hydrogen-absorbing alloy particles is 15 to 60 μm for example, preferably 20 to 50 μm.

In the present description, the average particle diameter means the median diameter (D₅₀) in the particle size distribution of the volume reference that is measured by a particle size distribution measuring device of laser diffraction type.

The alloy powder for electrodes can be produced by the following processes, for example:

(i) process A of producing an alloy from simple substances of the constituent elements of a hydrogen-absorbing alloy; and

(ii) process B of granulating the alloy obtained in process A.

After process B, (iii) process C of activating the granulated substance obtained in process B may be performed.

(i) Process A (Alloying Process)

In process A, using a known alloying method for example, an alloy can be produced from, as raw materials, the simple substances, alloys (alloy containing some elements of the constituent elements, for example ferrovanadium), and compounds of the constituent elements. More specifically, by mixing the raw materials and alloying the mixture in a molten state, an alloy can be obtained. The molten alloy is solidified before the granulation in process B. During mixing the raw materials, the molar ratio between the elements included in the raw materials and/or the mass ratio between the raw materials are adjusted so that the hydrogen-absorbing alloy has a desired composition.

As the alloying method, a plasma arc melting method, a high frequency melting method (metal mold casting method), a mechanical alloying method (machine alloy method), a mechanical milling method, and/or a rapid solidification method can be employed. The rapid solidification method specifically includes a roll spinning method, a melt drag method, a direct casting and rolling method, a rotating liquid spinning method, a spray forming method, a gas atomizing method, a wet spraying method, a splat method, a rapid-solidification thin strip grinding method, a gas atomization splat method, a melt extraction method, and/or a rotating electrode method. The rapid solidification methods are described in Metal Material Application Dictionary (Industrial Research Center of Japan, 1999) or the like. These alloying methods may be employed singly or in combination.

From the viewpoint of easily forming a plurality of alloy phases in which the percentage of Zr is 70 atom % or more, it is preferable to employ a rapid solidification method (rotating disk method, single roll method, or twin roll method). In the rapid solidification method, by pouring the molten alloy on a rotating disk or cooling roll and by rapidly cooling and solidifying it, a hydrogen-absorbing alloy can be produced. In the rapid solidification method, preferably, the molten alloy at 1500 to 1900° C. is cooled at a rate of 1200 to 2000° C./min, for example. It is preferable that the surface of the disk or cooling roll that comes into contact with the molten alloy can keep the temperature constant using a cooling water of a constant temperature (for example, 25° C.). The rotation speed of the disk or cooling roll may be 10 to 150 rpm, for example. The actual temperature on the disk or cooling roll is difficult to be directly measured. When the actual temperature is estimated on the basis of the cooling rate, the actual temperature is 50 to 80° C. during the process.

The solidified alloy may be heated (annealed) if necessary. By the heating, the dispersibility of the constituent elements in the hydrogen-absorbing alloy is easily adjusted, the elution and/or segregation of the constituent elements can be further effectively suppressed, and the hydrogen-absorbing alloy is easily activated.

The heating is not particularly limited, and can be performed at a temperature of 700 to 1200° C. in an atmosphere containing inert gas such as argon.

(ii) Process B (Granulating Process)

In process B, the alloy obtained in process A is granulated. The granulation of the alloy can be performed by wet crushing or dry crushing, or these methods may be combined together. The crushing can be performed using a ball mill or the like. In the wet crushing, the alloy that has been solidified using a liquid medium such as water is crushed. Obtained particles may be classified if necessary.

The alloy particles obtained in process B are sometimes referred to as “raw powder” of the alloy powder for electrodes.

(iii) Process C (Activating Process)

In process C, a crushed product (raw powder) can be activated by bringing the crushed product into contact with an alkaline aqueous solution. The method of bringing the raw powder into contact with the alkaline aqueous solution is not particularly limited. For example, the following process may be employed:

the raw powder is immersed in the alkaline aqueous solution;

the raw powder is added to the alkaline aqueous solution and they are stirred; or

the alkaline aqueous solution is sprayed to the raw powder.

The activation may be performed in the heating state, if necessary.

As the alkaline aqueous solution, an aqueous solution that contains an alkali metal hydroxide or the like as an alkaline component can be employed. The alkali metal hydroxide is, for example, potassium hydroxide, sodium hydroxide, and/or lithium hydroxide. Among them, preferably, sodium hydroxide and/or potassium hydroxide are used.

From the viewpoint of the efficiency of activation, the productivity, and/or the reproducibility of a process, the alkali concentration in the alkaline aqueous solution is 5 to 50 mass % for example, preferably 10 to 45 mass %.

After the activation treatment by the alkaline aqueous solution, the obtained alloy powder may be washed with water. In order to reduce the remaining of impurities on the surface of the alloy powder, it is preferable that the wash with water is finished after the pH of the water used for the wash becomes 9 or less.

The alloy powder after the activation treatment is normally dried.

The alloy powder for electrodes in accordance with the exemplary embodiment of the present invention can be obtained through these processes. The obtained alloy powder has a high capacity and a low hydrogen equilibrium pressure. Therefore, the alloy powder for electrodes in accordance with the exemplary embodiment is appropriate for use as a negative electrode active material of a nickel-hydrogen storage battery.

(Nickel-Hydrogen Storage Battery)

A nickel-hydrogen storage battery includes a positive electrode, a negative electrode, a separator interposed between the positive electrode and negative electrode, and an alkaline electrolytic solution.

The negative electrode includes the above-mentioned alloy powder for electrodes as the negative electrode active material.

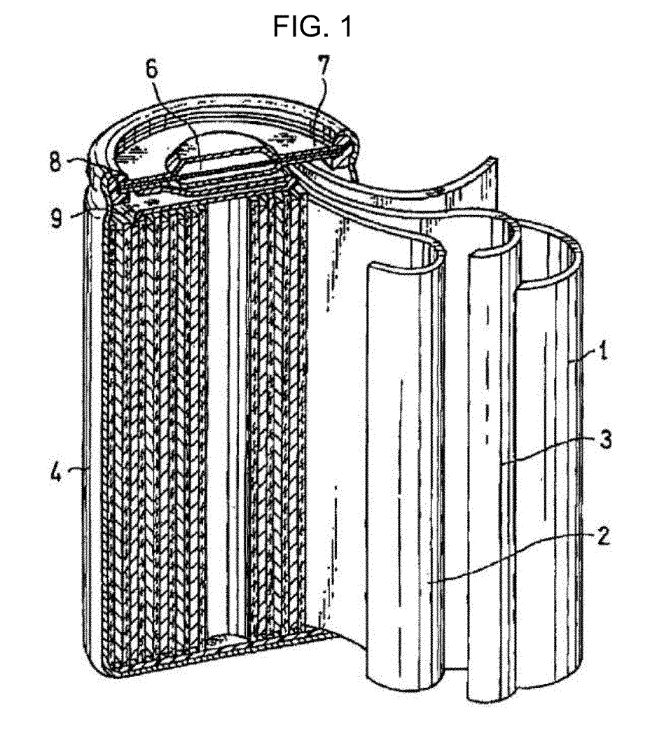

The configuration of the nickel-hydrogen storage battery is described hereinafter with reference to FIG. 1. FIG. 1 is a vertical sectional view schematically showing the structure of a nickel-hydrogen storage battery in accordance with the exemplary embodiment of the present invention. The nickel-hydrogen storage battery includes bottomed cylindrical battery case 4 serving also as a negative electrode terminal, an electrode group stored in battery case 4, and an alkaline electrolytic solution (not shown). In the electrode group, negative electrode 1, positive electrode 2, and separator 3 interposed between them are wound spirally. Sealing plate 7 having safety valve 6 is disposed in an opening in battery case 4 via insulating gasket 8. By caulking the opening end of battery case 4 inward, the nickel-hydrogen storage battery is sealed. Sealing plate 7 serves also as a positive electrode terminal, and is electrically connected to positive electrode 2 via positive electrode lead 9.

Such a nickel-hydrogen storage battery can be obtained by storing the electrode group in battery case 4, injecting the alkaline electrolytic solution, placing sealing plate 7 in the opening in battery case 4 via insulating gasket 8, and caulking and sealing the opening end of battery case 4. At this time, negative electrode 1 of the electrode group is electrically connected to battery case 4 via a negative-electrode current collector disposed between the electrode group and the inner bottom of battery case 4. Positive electrode 2 of the electrode group is electrically connected to sealing plate 7 via positive electrode lead 9.

Next, the components of a nickel-hydrogen storage battery are more specifically described.

(Negative Electrode)

The negative electrode is not particularly limited as long as it includes the above- mentioned alloy powder for electrodes as the negative electrode active material. As another component, a known component used in a nickel-hydrogen storage battery can be employed.

The negative electrode may include a core member, and a negative electrode active material adhering to the core member. Such a negative electrode can be formed by applying, to the core member, a negative electrode paste including at least a negative electrode active material.

As the negative electrode core member, a known member can be employed. The negative electrode core member can be exemplified by a porous or imperforate substrate made of a stainless steel, nickel, or an alloy of them. When the core member is a porous substrate, an active material may be filled in a hole of the core member.

The negative electrode paste normally includes a dispersion medium. If necessary, a known component—for example, a conductive agent, binder, and/or thickener—used for the negative electrode may be added to the paste.

The negative electrode, for example, can be formed by applying the negative electrode paste to the core member, then removing the dispersion medium through drying, and compressing (or rolling) them.

As the dispersion medium, a known medium such as water, an organic medium, or a mixed medium of them can be employed.

The conductive agent is not particularly limited as long as it is an electronically conductive material. Examples of the conductive agent include: graphite (natural graphite or artificial graphite), carbon black, conductive fiber, and/or an organic conductive material.

The amount of the conductive agent to 100 pts.mass of alloy powder for electrodes is 0.01 to 50 pts.mass for example, preferably 0.1 to 30 pts.mass. The conductive agent may be added to the negative electrode paste, or may be used as a mixture with another component. The conductive agent may be previously applied to the surface of the alloy powder for electrodes.

The binder is made of a resin material. Examples of the resin material include: a rubber material such as styrene-butadiene copolymer rubber (SBR); a polyolefin resin; a fluorine resin such as polyvinylidene fluoride; and/or an acrylic resin (its Na ion crosslinked polymer).

The amount of the binder to 100 pts.mass of alloy powder for electrodes is 0.01 to 10 pts.mass for example, preferably 0.05 to 5 pts.mass.

Examples of the thickener include: a cellulose derivative such as carboxymethyl cellulose (CMC) or modified CMC (including salt such as Na salt); polyvinyl alcohol; and/or polyethylene oxide.

The amount of the thickener to 100 pts.mass of alloy powder for electrodes is 0.01 to 10 pts.mass for example, preferably 0.05 to 5 pts.mass.

(Positive Electrode)

The positive electrode may include a core member, and an active material or an active material layer adhering to the core member. The positive electrode may be an electrode formed by sintering active material powder.

The positive electrode can be formed by applying, to the core member, a positive electrode paste that includes at least a positive electrode active material, for example. More specifically, the positive electrode can be formed by applying the positive electrode paste to the core member, then removing the dispersion medium through drying, and compressing (or rolling) them.

As the positive electrode core member, a known member can be employed. The positive electrode core member can be exemplified by a porous substrate made of a nickel foam and a nickel or nickel alloy such as a sintered nickel plate.

As the positive electrode active material, for example, a nickel compound such as nickel hydroxide and/or nickel oxyhydroxide is employed.

The positive electrode paste normally includes a dispersion medium. If necessary, a known component—for example, a conductive agent, binder, and/or thickener—used for the positive electrode may be added to the positive electrode paste. The dispersion medium, the conductive agent, the binder, the thickener, and their amounts can be selected from the materials and ranges similar to those in the case of the negative electrode paste. As the conductive agent, a conductive cobalt oxide such as cobalt hydroxide and/or cobalt γ-oxyhydroxide may be employed. The positive electrode paste may include, as an additive, a metal compound (oxide and/or hydroxide) such as zinc oxide and/or zinc hydroxide.

(Separator)

As a separator, a known material—for example, a microporous film, a non-woven fabric, or a laminated body of them—used for a nickel-hydrogen storage battery can be employed. Examples of the material of the microporous film or non-woven fabric can include a polyolefin resin such as polyethylene or polypropylene, a fluorine resin, and/or a polyamide resin. Considering that a polyolefin resin has a high degradation resistance against the alkaline electrolytic solution, it is preferable to employ a separator made of the polyolefin resin.

Preferably, through a hydrophilic treatment, a hydrophilic group is previously introduced to the separator made of a material having a high hydrophobicity, such as the polyolefin resin. As an example of the hydrophilic treatment, a corona discharge treatment, a plasma treatment, or a sulfonation treatment can be employed. To the separator, one of these hydrophilic treatments may be applied, or a combination of two or more may be applied.

Preferably, at least a part of the separator is sulphonated. The sulfonation degree of the separator (resin-made separator or the like) is 1×10⁻³ to 4.3×10⁻³for example, preferably 1.5×10⁻³ to 4.1×10⁻³. The sulfonation degree of the separator (resin-made separator or the like) is indicated by the ratio of sulfur atoms to carbon atoms included in the separator.

In the separator having undergone the hydrophilic treatment such as the sulfonation treatment, even when a metal component (a metal element located in the B site) such as Co and/or element E (Mn or the like) is eluted by the interaction between element M (Mg or the like) eluted from an alloy and a hydrophilic group introduced to the separator, these metal components can be captured and inactivated. Therefore, the phenomenon in which precipitation of the eluted metal component causes a micro short circuit and/or decreases the self-discharge characteristic is easily suppressed. Thus, the long-term reliability of the battery can be improved and a high self-discharge characteristic can be secured for a long time.

The thickness of the separator can be appropriately selected from the range of 10 to 300 μm, for example. The thickness may be in the range of 15 to 200 μm, for example.

Preferably, the separator has a non-woven fabric structure. As an example of the separator having a non-woven fabric structure, a non-woven fabric, or a laminated body of a non-woven fabric and a microporous film can be employed.

(Alkaline Electrolytic Solution)

As the alkaline electrolytic solution, for example, an aqueous solution containing an alkaline component (alkaline electrolyte) is employed. As an example of the alkaline component, an alkali metal hydroxide—for example, lithium hydroxide, potassium hydroxide, or sodium hydroxide—can be employed. These compounds can be used singly or as a combination of two or more.

From the viewpoint of suppressing the self-decomposition of the positive electrode active material and easily suppressing the self-discharge, preferably, the alkaline electrolytic solution includes at least sodium hydroxide as an alkaline component. The alkaline electrolytic solution may include at least one compound selected from a set consisting of sodium hydroxide, potassium hydroxide, and lithium hydroxide.

From the viewpoint of a high-temperature conservation characteristic and a high-temperature life characteristic, the concentration of sodium hydroxide in the alkaline electrolytic solution may be 9.5 to 40 mass %.

When the alkaline electrolytic solution includes potassium hydroxide, the ion conductivity of the electrolytic solution is easily increased and the output is easily increased. The concentration of the potassium hydroxide in the alkaline electrolytic solution may be 0.1 to 40.4 mass %.

When the alkaline electrolytic solution includes lithium hydroxide, the oxygen overvoltage is easily increased. When the alkaline electrolytic solution includes lithium hydroxide, from the viewpoint of securing a high ion conductivity of the alkaline electrolytic solution, the concentration of the lithium hydroxide in the alkaline electrolytic solution may be 0.1 to 1 mass %, for example.

The specific gravity of the alkaline electrolytic solution is 1.03 to 1.55 for example, preferably 1.11 to 1.32.

### EXAMPLE

Hereinafter, the present invention is specifically described on the basis of examples and comparative examples. The present invention is not limited to the following examples.

### Example 1

(1) Production of Hydrogen-Absorbing Alloy Particles

The simple substances of Zr, Ti, Ni, Mn, and Al are mixed at mass percentages of 42.0: 2.2: 34.7: 16.3: 3.2 (=Zr: Ti: Ni: Mn: Al), and are molten by a high-frequency melting furnace. The molten metal is poured on a cooling roll to be rapidly cooled and solidified, and is annealed. According to the SEM photograph of the cross section of a flake-like alloy obtained in this manner, an auxiliary phase (interface layer) is formed on or near the interface between adjacent crystal particles in the main phase.

The flake-like alloy is crushed in a tungsten mortar. The crushed products are classified, and powder (raw powder) having a particle diameter of 20 to 50 μm is collected. Average particle diameter D₅₀ of the raw powder is 40 μm.

(2) Production of Alloy Powder for Electrodes

The raw powder obtained in process (1) is mixed with an alkaline aqueous solution of a temperature of 100° C. that contains sodium hydroxide at a concentration of 40 mass %, and they are continuously stirred for 50 minutes. The obtained powder is collected, washed with hot water, dehydrated, and then dried. The washing is continued until the pH of the hot water after use becomes 9 or less. As a result, alloy powder for electrodes from which impurities have been removed is obtained.

(3) Production of Negative Electrode

To 100 pts.mass of alloy powder for electrodes obtained in process (2), 0.15 pts.mass of CMC (degree of etherification of 0.7, and degree of polymerization of 1600), 0.3 pts.mass of acetylene black, and 0.7 pts.mass of SBR are added, and further water is added. They are kneaded to prepare an electrode paste. The obtained electrode paste is applied to both surfaces of a core member that is made of an iron punching metal plated with nickel (thickness of 60 μm, hole diameter of 1 mm, and open area percentage of 42%). The applied paste is dried, and then pressed together with the core member by a roller. Thus, a negative electrode of a thickness of 0.4 mm, a width of 35 mm, and a capacity of 2200 mAh is obtained. An exposed portion of the core member is disposed at one end of the negative electrode along the longitudinal direction.

(4) Production of Positive Electrode

A sintered positive electrode of a capacity of 1500 mAh is obtained by filling nickel hydroxide into a porous sintered substrate as a positive electrode core member. As a positive electrode active material, about 90 pts.mass of Ni(OH)₂ is employed. To the positive electrode active material, about 6 pts.mass of Zn(OH)₂ is added as an additive, and about 4 pts.mass of Co(OH)₂ is added as a conductive material. An exposed portion of the core member having no active material is disposed at one end of the positive electrode core member along the longitudinal direction.

(5) Production of Nickel-Hydrogen Storage Battery

A nickel-hydrogen storage battery of 4/5 A size with a nominal capacity of 1500 mAh shown in FIG. 1 is produced using the negative electrode and positive electrode that are obtained in the above-mentioned method. Specifically, positive electrode 2 and negative electrode 1 are wound via separator 3 to produce a cylindrical electrode group. In the electrode group, the exposed portion of the positive electrode core member having no positive electrode mixture and the exposed portion of the negative electrode core member having no negative electrode mixture are exposed on the opposite end surfaces. As separator 3, non-woven fabric (thickness of 100 μm, mass per unit area of 50 g/cm², and sulfonation degree of 1.90×10⁻³) made of sulfonated polypropylene is employed. A positive electrode current collector is welded to the end surface of the electrode group on which the positive electrode core member is exposed. A negative electrode current collector is welded to the end surface of the electrode group on which the negative electrode core member is exposed.

Sealing plate 7 is electrically connected to the positive electrode current collector via positive electrode lead 9. Then, the electrode group is stored in battery case 4 formed of a cylindrical bottomed-can in the state where the negative electrode current collector is disposed on the downside. The negative electrode lead connected to the negative electrode current collector is welded to the bottom of battery case 4. The electrolytic solution is injected into battery case 4, and then the opening of battery case 4 is sealed with sealing plate 7 having gasket 8 on its periphery. Thus, the nickel-hydrogen storage battery (battery Al) is completed. The standard capacity of the battery is set at 1000 mAh.

In the electrolytic solution, as an alkaline component, an alkaline aqueous solution (specific gravity: 1.23) that contains sodium hydroxide by 31 mass %, potassium hydroxide by 1 mass %, and lithium hydroxide by 0.5 mass % is employed.

(6) Evaluation

The flake-like hydrogen-absorbing alloy, alloy powder for electrodes, or nickel-hydrogen storage battery that is obtained in the above-mentioned manner is evaluated as below.

(a) Crystal Structure

The B/A ratio is obtained by measuring the percentages (molar ratio) of the constituent elements in the main phase and in the auxiliary phase by powder X-ray diffraction (XRD) of the alloy powder for electrodes. Similarly, the percentage (atom %) of Zr in each of the main phase and the auxiliary phase is calculated.

(b) Surface Area Percentage of Auxiliary Phase

In the SEM photograph (reflection electron image photograph) of the cross section of the flake-like alloy obtained in process (1), the surface area of the auxiliary phase in each of optionally selected predetermined-regions (10 μm (height) by 10 μm (width)) is determined, and the surface area percentage (%) in the all regions is calculated. A similar measurement is performed for a total of 10 regions, and the average value (%) of the surface area percentages of the auxiliary phase is calculated.

(c) Discharge Capacity (Theoretical Value)

The theoretical value of the discharge capacity (mAh) of the battery is calculated on the basis of the amount of positive electrode active material used for the positive electrodes.

(d) Initial Activity

The nickel-hydrogen storage battery is charged for 16 hours in the environment of 20° C. at a current value of 0.15 A. Then, the charged nickel-hydrogen storage battery is discharged in the environment of 20° C. at a current value of 0.3 A until the battery voltage decreases to 1.0 V, and the discharge capacity (initial discharge capacity, unit: mAh) at this time is measured. Then, the percentage (%) of the value of the initial discharge capacity to the theoretical capacity is calculated, and is set as the index of the initial activity.

(e) Rate Characteristic

The nickel-hydrogen storage battery is charged in the environment of 20° C. at a current value of 0.75 A until the capacity becomes 120% of the theoretical capacity. Then, the nickel-hydrogen storage battery after the charge is discharged in the environment of 20° C. at a current value of 0.3 A until the battery voltage decreases to 1.0 V, and the discharge capacity (0.2 It discharge capacity, unit: mAh) at this time is measured.

Furthermore, the nickel-hydrogen storage battery after the measurement of the 0.2 It discharge capacity is charged in the environment of 20° C. at a current value of 0.75 A until the capacity becomes 120% of the theoretical capacity. Then, the nickel-hydrogen storage battery after the charge is discharged in the environment of 20° C. at a current value of 3 A until the battery voltage decreases to 1.0 V, and the discharge capacity (2 It discharge capacity, unit: mAh) at this time is measured. Then, the percentage (%) of the 2It discharge capacity to the 0.2 It discharge capacity is set as the index of the rate characteristic.

(f) Low-Temperature Discharge Characteristic

The nickel-hydrogen storage battery is charged in the environment of 20° C. at a current value of 1.5 A until the capacity becomes 120% of the theoretical capacity. Then, the nickel-hydrogen storage battery after the charge is discharged in the environment of 20° C. at a current value of 3.0 A until the battery voltage decreases to 1.0 V, and the discharge capacity (initial discharge capacity, unit: mAh) at this time is measured.

Furthermore, the nickel-hydrogen storage battery after the measurement of the initial discharge capacity is charged in the environment of 20° C. at a current value of 1.5 A until the capacity becomes 120% of the theoretical capacity. Then, the nickel-hydrogen storage battery after the charge is discharged in the environment of −10° C. at a current value of 3.0 A until the battery voltage decreases to 1.0 V, and the discharge capacity (low-temperature discharge capacity, unit: mAh) at this time is measured. Then, the percentage (%) of the low-temperature discharge capacity to the initial discharge capacity is set as the index of the low-temperature discharge characteristic.

### Examples 2 to 6

Alloy powder for electrodes and a nickel-hydrogen storage battery are produced as in example 1 except that the simple substances as raw materials are mixed at the percentages at which the hydrogen-absorbing alloy has the composition shown in Table 1.

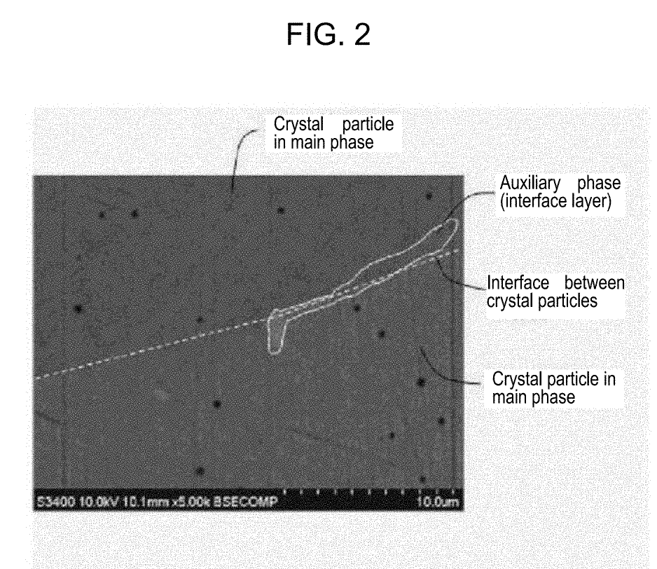

FIG. 2 shows an SEM photograph of the cross section of a flake-like alloy (hydrogen-absorbing alloy) obtained in example 2. In FIG. 2, the dotted line shows the interface between adjacent crystal particles in the main phase. In the hydrogen-absorbing alloy obtained in example 2, an auxiliary phase (interface layer) is formed on (or near) the interface.

Example 7

The simple substances of Zr, Ti, Ni, Mn, Al, and V are mixed at the percentages at which the hydrogen-absorbing alloy has the composition shown in Table 1, and are molten by the high-frequency melting furnace. Raw powder is obtained as in example 1 except that this molten metal is used. Alloy powder for electrodes and a nickel-hydrogen storage battery are produced and evaluated as in example 1 except that the raw powder produced in such a manner is used.

### Comparative Example 1

The simple substances of Zr, Ni, Mn, and Cr are mixed at the percentages at which the hydrogen-absorbing alloy has the composition shown in Table 1, and are molten by the high-frequency melting furnace. Raw powder is obtained as in example 1 except that this molten metal is used. Alloy powder for electrodes and a nickel-hydrogen storage battery are produced and evaluated as in example 1 except that the raw powder produced in such a manner is used.

### Comparative Example 2

The simple substances of Zr, Ti, Ni, Mn, and Co are mixed at the percentages at which the hydrogen-absorbing alloy has the composition shown in Table 1, and are molten by the high-frequency melting furnace. Raw powder is obtained as in example 1 except that this molten metal is used. Alloy powder for electrodes and a nickel-hydrogen storage battery are produced and evaluated as in example 1 except that the raw powder produced in such a manner is used.

### Comparative Example 3

The simple substances of Zr, Ni, Mn, and Co are mixed at the percentages at which the hydrogen-absorbing alloy has the composition shown in Table 1, and are molten by the high-frequency melting furnace. Raw powder is obtained as in example 1 except that this molten metal is used. Alloy powder for electrodes and a nickel-hydrogen storage battery are produced and evaluated as in example 1 except that the raw powder produced in such a manner is used.

### Comparative Example 4

The simple substances of Zr, Ti, Ni, Mn, and Si are mixed at the percentages at which the hydrogen-absorbing alloy has the composition shown in Table 1, and are molten by the high-frequency melting furnace. Raw powder is obtained as in example 1 except that this molten metal is used. Alloy powder for electrodes and a nickel-hydrogen storage battery are produced and evaluated as in example 1 except that the raw powder produced in such a manner is used.

The results of examples 1 to 7 and comparative examples 1 to 4 are shown in Table 1. Here, A1 to A7 correspond to examples 1 to 7, and B1 to B4 correspond to comparative examples 1 to 4.

TABLE 1

| | | | | | | | | | | | | | | | | Low- |
|---|---|---|---|---|---|---|---|---|---|---|---|---|---|---|---|---|
| | Main phase: Zr₁₋ₐ₁Tiₐ₁NiₓMn_{y}Al_{z1}E¹_{z2} | | | | | | | | | Auxiliary phase | | | | | | temperature |
| | | | | | | | | R_{zp} | r_{zp} | R_{zs} | r_{zs} | Surface area | Discharge | Initial | Rate | discharge |
| | | | | | | | B/A | (atom | (atom | (atom | (atom | percentage | capacity | activity | characteristic | characteristic |
| | α¹ | x | y | z¹ | E¹ | z² | ratio | %) | %) | %) | %) | (%) | (mAh) | (%) | (%) | (%) |
| A1 | 0.090 | 1.166 | 0.586 | 0.236 | — | — | 1.99 | 95.02 | 26.25 | 86.93 | 36.90 | 1.80 | 1045.8 | 96.21 | 90.05 | 69.73 |
| A2 | 0.098 | 1.331 | 0.586 | 0.258 | — | — | 2.17 | 94.60 | 26.02 | 86.55 | 36.58 | 1.83 | 1042.2 | 95.80 | 89.66 | 67.89 |
| A3 | 0.099 | 1.276 | 0.576 | 0.334 | — | — | 2.19 | 94.52 | 25.99 | 86.48 | 36.54 | 1.50 | 1089.1 | 95.61 | 89.19 | 69.73 |
| A4 | 0.097 | 1.212 | 0.564 | 0.401 | — | — | 2.18 | 94.63 | 26.05 | 86.58 | 36.62 | 1.15 | 1059.8 | 94.19 | 88.97 | 69.31 |
| A5 | 0.131 | 1.056 | 0.542 | 0.347 | — | — | 1.94 | 92.69 | 25.07 | 84.80 | 35.24 | 0.70 | 1069.5 | 94.34 | 88.87 | 68.93 |
| A6 | 0.097 | 1.108 | 0.553 | 0.421 | — | — | 2.08 | 94.68 | 26.05 | 86.62 | 36.62 | 0.50 | 1070.8 | 90.15 | 88.18 | 62.00 |
| A7 | 0.094 | 1.149 | 0.505 | 0.248 | V | 0.096 | 2.00 | 94.88 | 26.14 | 86.81 | 36.74 | 2.20 | 1083.6 | 83.54 | 77.31 | 58.93 |
| B1 | 0. | 1.196 | 0.597 | 0. | Cr | 0.207 | 2.00 | 100. | 28.85 | — | — | 0. | 1044.6 | — | — | — |
| B2 | 0.089 | 1.202 | 0.600 | 0. | Co | 0.201 | 2.00 | 95.13 | 26.28 | — | — | 0. | 1070.4 | — | — | — |
| B3 | 0. | 1.255 | 0.626 | 0. | Co | 0.238 | 2.11 | 100. | 28.85 | — | — | 0. | 1044.1 | — | — | — |
| B4 | 0.099 | 1.173 | 0.556 | 0. | Si | 0.384 | 2.11 | 94.54 | 25.99 | — | — | 0. | 1061.5 | — | — | — |

As shown in Table 1, the examples include an alloy in which the Zr percentage in the A-site elements is 70 atom % or more in both of the main phase and the auxiliary phase. In each example, a high rate characteristic and a high low-temperature discharge characteristic are obtained while a high capacity is secured. In the examples, the initial activity is also high.

While, in the comparative examples, auxiliary phases similar to those in the examples are not observed. In the comparative examples, a relatively high capacity is obtained. However, the hydrogen equilibrium pressure in the alloy is excessively high, and hence, during the initial charge of the battery, the inner pressure extremely increases to operate the safety valve and cause a leak of liquid. Therefore, the initial activity, rate characteristic, and low-temperature discharge characteristic cannot be evaluated. Thus, the battery in each comparative example does not serve as a storage battery.

In the exemplary embodiment of the present invention, the capacity of a nickel-hydrogen storage battery can be increased, and alloy powder for electrodes having a low equilibrium pressure can be produced. The rate characteristic is high, and low-temperature discharge characteristic is high. Therefore, this nickel-hydrogen storage battery is expected to be used as an alternative of a dry battery and as a power source for various apparatuses, and can be expected to be used as a power source for a hybrid automobile or the like.

1. Alloy powder for electrodes, comprising
particles of a hydrogen-absorbing alloy having an AB₂ type crystal structure, wherein
the hydrogen-absorbing alloy includes:
first elements located in an A site in the crystal structure and including Zr; and
second elements located in a B site in the crystal structure and including Ni and Mn,
the hydrogen-absorbing alloy includes a plurality of alloy phases having different Zr concentrations, and
in each of the plurality of alloy phases, a percentage of Zr in the first elements exceeds 70 atom %.

2. The alloy powder for electrodes according to claim 1, wherein
the plurality of alloy phases include a main phase and an auxiliary phase formed in the main phase.

3. The alloy powder for electrodes according to claim 2, wherein
in the main phase, an atom ratio (B/A ratio) of the second elements to the first elements is 1.90 to 2.40 inclusive.

4. The alloy powder for electrodes according to claim 2, wherein
a percentage R_{zp} of Zr in the first elements in the main phase and a percentage R_{zs} of Zr in the first elements in the auxiliary phase satisfy 1.00<R_{zp}/R_{zs}≦1.50.

5. The alloy powder for electrodes according to claim 2, wherein
a surface area percentage of the auxiliary phase in a cross section of the hydrogen-absorbing alloy is 0.1 to 20% inclusive.

6. The alloy powder for electrodes according to claim 2, wherein
in the main phase, a molar ratio x of Ni to the first elements satisfies 0.90≦x≦1.50.

7. The alloy powder for electrodes according to claim 2, wherein
in the main phase, a molar ratio y of Mn to the first elements satisfies 0.40≦y≦1.10.

8. The alloy powder for electrodes according to claim 1, wherein
the first elements further include Ti.

9. The alloy powder for electrodes according to claim 1, wherein
the second elements further include Al.

10. The alloy powder for electrodes according to claim 9, wherein
a molar ratio z¹ of Al to the first elements satisfies 0.15≦z¹≦0.45.

11. The alloy powder for electrodes according to claim 1, wherein
the second elements further include at least one element selected from a set consisting of Co, Cr, Si, and V.

12. The alloy powder for electrodes according to claim 1, wherein
the alloy powder is activated by an alkali treatment.

13. A negative electrode for nickel-hydrogen storage batteries, the negative electrode comprising, as a negative electrode active material, the alloy powder for electrodes according to claim 1.

14. A nickel-hydrogen storage battery comprising:
a positive electrode;
the negative electrode according to claim 13;
a separator interposed between the positive electrode and the negative electrode; and
an alkaline electrolytic solution.
